(19) United States
(12) Patent Application Publication
(10) Pub. No.: US 2006/0045826 A1
(43) Pub. Date: Mar. 2, 2006

(54) Apparatus and method to generate pressurized ozone gas

(76) Inventor: Robert A. Mullaney, Benicia, CA (US)

Correspondence Address: C. Bart Sullivan, 1543 Sherman Dr., Benicia, CA, 94510, US

(21) Appl. No.: 10/927,356

(22) Filed: Aug. 26, 2004

(51) Int. Cl. B01J 19/08; B01J 19/12

(52) U.S. Cl. 422/186.22; 422/186.07

(57) ABSTRACT

An apparatus and method to generate ozone gas at a pressure significantly higher than ambient atmospheric pressure is described. In one embodiment, a dielectric plate is positioned in a floating arrangement within an insulated process cavity defined by a lower gasket, a window gasket, an upper gasket, and an electrode plate. A sealing plate is positioned on an exterior portion of the upper gasket. In one configuration, the sealing pate includes a sealing structure extending therefrom and in contact with the upper gasket. The sealing structure is configured to provided a focused sealing force to the upper gasket, window gasket, and lower gasket to seal and enable the process cavity to produce ozone within a predetermined range of output ozone gas pressure that is significantly greater than a surrounding ambient atmospheric pressure.

### BACKGROUND OF THE INVENTION

1. Field of the Invention

Embodiments of the present invention generally relate to ozone generators and more specifically to flat plate corona discharge ozone generators.

2. Description of the Related Art

Generally, ozone is often used as a powerful oxidant to oxidize materials and for sterilization of materials, environments, etc. For example, ozone is often used in petrochemical industry for converting hydrocarbons such as olefins into aldehydes, keytones, carboxylic acid, and is often used as a bleaching agent to sterilize food and water.

Ozone is currently generated using several different techniques. One such ozone generation technique involves producing ozone by passing oxygen though a flat or annular gap between two electrodes separated by a dielectric. A high voltage AC voltage is applied across the electrodes to generate an electric field that provides a high-energy corona discharge therebetween. Oxygen (O₂) is passed between the plates through the corona discharge. Some oxygen molecules passing through the corona discharge are split and recombined into a trivalent oxygen molecule (O₃), i.e., ozone gas.

While ozone has become a major chemical agent for use in many industries, unfortunately, ozone cannot be stored for any length of time without reverting to oxygen. Therefore, ozone must be produced on-site to provide ozone in sufficient quantities to be effective for use in a particular process such as oxidation and sterilization.

Often, ozone must be pressurized so that it may be efficiently injected into environments such as water. Unfortunately, conventional ozone generators tend to leak as the supply gas pressure is raised significantly above the ambient operational atmospheric pressure. When the process gas pressure is increased, the process and ozone gases typically leak into the surrounding ambient atmosphere contaminating the immediate environment and lowering the effective ozone concentration for the intended process. Further, if process gas pressure is raised significantly enough from the surrounding ambient pressure ozone production, a process leak may become so severe that ozone production may cease almost entirely and is therefore useless for systems requiring pressures at or above such a leak pressure point. Additionally, such pressurized process and ozone gas may create undue stress on internal components of conventional ozone generators exposed to differential pressures, as the process gas pressure may be considerably greater than the surrounding ambient atmospheric pressure.

Currently, the industry has provided some techniques to solve the problems of generating ozone gas at a pressure significantly greater than ambient atmospheric pressure. One conventional technique to produce ozone at a higher gas pressure is compressing ozone gas with a compressing apparatus such as a compressor. Unfortunately, when ozone gas is pressurized using an external compressing apparatus, a large portion of the ozone is converted to oxygen thereby reducing the effective concentration of ozone in the pressurized ozone gas. Lowering such ozone concentration using a compressor is undesirable as it increases system complexity and generally requires either extensive modifications of an existing ozone generator, or procuring a higher output ozone generator, to supply an increased ozone concentration to the compressor, which generally increases ozone production costs.

Another conventional technique uses an external pressurized chamber to solve problems associated with processing process gas at higher pressures. Ozone gas may be produced at a higher pressure by enclosing an ozone generator in a pressure chamber. In such pressure chambers, both the interior pressure and exterior atmospheric pressure experienced by the ozone generator are the same. Therefore, the pressures experienced by the ozone generator and internal ozone generation elements thereof, such as electrodes and dielectric plates, are balanced thereby reducing internal stresses. Further, such chambers reduce leakage of both the process gas and produced ozone gas as the pressure chamber is designed to accommodate a higher internal gas pressure than the surrounding ambient pressure. Unfortunately, such high-pressure ozone production chambers are significantly more expensive and complicated, as specialized high pressure process gas inputs connections, gas output connections, and power supply connections, etc., must be used.

Generally, in such external pressure chamber systems, heat exchange between the ozone generator and the ambient environment is often compromised which can result in increased failure rates for internal components due to increased heat expansion. For example, air-cooling such enclosed ozone generators is more complicated as air driven heat exchange systems must extract heat from the ozone generator inside the pressure chamber and pass the heat though the internal higher pressure environment to the outside environment. Further, as many ozone generators require the use of water or other fluids as a coolant, placing an ozone generator inside such a pressure chamber also requires complicated and more costly fluid based heat exchange systems designed to compensate for the increased internal pressures and heat transfer inefficiencies.

Therefore, what is needed is a method and apparatus to efficiently and economically produce ozone gas at a pressure significantly greater than an ambient atmospheric pressure external to the ozone generator while allowing for a simple and efficient heat transfer into an ambient air pressure.

### SUMMARY OF THE INVENTION

An aspect of the present invention is an apparatus configured to generate high pressure ozone gas from a high pressure process gas containing oxygen. The apparatus includes a sealing plate, an upper gasket disposed on the sealing plate, a window gasket disposed on the upper gasket, a lower gasket disposed on the window gasket, and an electrode plate disposed on the lower gasket. The electrode plate, the lower gasket, the window gasket, and the upper gasket, cooperate to form a pressurizable process chamber. The apparatus includes a dielectric plate disposed within the pressurizable process chamber in a dielectric plate receiving space defined by the window gasket, the upper gasket, and the lower gasket. The dielectric plate receiving space is sized to allow the dielectric plate to expand and contract without resistance over a range of operational temperatures. The apparatus also includes at least one electrical contact extending between the sealing plate through an opening in the upper gasket to electrically connect a conductive side of the dielectric plate to the sealing plate, a power source electrically connected to the electrode plate and the at least one electrical contact, and at least one gas input integral to the electrode plate. The at least one gas input is configured to couple the high pressure process gas into the pressurizable process chamber. The apparatus also includes at least one gas output integral to the electrode plate configured to output the high pressure ozone gas from the pressurizable process chamber. A sealing member is disposed between the sealing plate and the upper gasket. The sealing member being configured to apply a focused sealing force that extends through the upper gasket, the window gasket, and the lower gasket such that a seal is formed around the pressurizable process chamber. The seal provides a sufficient pressure seal to allow gas pressure within the pressurizable process chamber to be at least about three times greater than an ambient atmospheric pressure external to the apparatus.

An aspect of the present invention is an ozone generator configured to receive a process gas containing oxygen under pressure, process such process gas, and output ozone gas at a pressure greater than ambient air pressure. The ozone generator includes an insulated body configured with an expansion cavity disposed adjacent a corona discharge cavity and a dielectric plate disposed within the expansion cavity. The expansion cavity being sized to allow the dielectric plate to expand and contract within the expansion cavity without resistance. The ozone generator includes an electrode plate disposed adjacent the corona discharge cavity and the dielectric plate, and a sealing plate having a sealing means disposed adjacent thereto and extending therefrom toward the electrode plate. The sealing means is configured to provide a sealing force that extends through the insulated body sufficient to provide a process gas seal about the corona discharge cavity and the expansion cavity. The sealing force being of sufficient magnitude to allow the ozone generator to receive the process gas therein at a process gas pressure of at least about three times greater than the ambient air pressure surrounding the insulated body and output the ozone gas at about the process gas pressure.

An aspect of the present invention is a method of generating high pressure ozone gas within an internal ozone generation chamber configured to accommodate a process gas containing oxygen under pressure greater than an ambient atmospheric pressure. The method includes providing an insulated process chamber configured to receive the process gas under pressure. The insulated process chamber includes a dielectric expansion chamber configured to support a dielectric plate therein without resistance, and a corona discharge chamber. The method further includes positioning a sealing plate on one side of the insulated process chamber, positioning an electrode plate on another side of the insulated process chamber adjacent the dielectric plate to define the corona discharge chamber, providing the process gas to the corona discharge chamber, and generating a corona discharge within the corona discharge chamber to produce the high pressure ozone gas. The method includes providing a sealing member extending from the sealing plate toward the insulated process chamber. The sealing member is configured to engage with the insulated process chamber with sufficient force to generate a sealing force extending though the insulated process chamber between the sealing plate and the electrode plate. The sealing force being sufficient to allow the insulated process chamber to accommodate the process gas at a pressure of at least about three times greater than the ambient air pressure surrounding the insulated process chamber.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the present invention may admit to other equally effective embodiments.

FIG. 1 is a perspective view of one embodiment of an ozone generator in accordance with embodiments of the invention.

FIG. 2 is an exploded perspective view of one embodiment of an ozone generator of FIG. 1 in accordance with embodiments of the invention.

FIG. 3 is a frontal cross sectional view of one embodiment of an ozone generator of FIG. 1 in accordance with embodiments of the invention.

FIG. 4 is an enlarged view of one side of an ozone generator of FIG. 3 in accordance with embodiments of the invention.

FIG. 5A is a top view of one embodiment of a sealing plate in accordance with embodiments of the invention.

FIG. 5B is a side view of one embodiment of a sealing plate in accordance with embodiments of the invention.

FIG. 5C is an enlarged partial view of one embodiment of a sealing plate in accordance with embodiments of the invention.

FIG. 5D is an enlarged partial view of one embodiment of a sealing plate in accordance with embodiments of the invention.

FIG. 6A is a top view of one embodiment of a sealing plate in accordance with embodiments of the invention.

FIG. 6B is a side view of one embodiment of a sealing plate in accordance with embodiments of the invention.

FIG. 6C is an enlarged partial view of one embodiment of a sealing plate in accordance with embodiments of the invention.

FIG. 6D is an enlarged partial view of one embodiment of a sealing plate in accordance with embodiments of the invention.

FIG. 7A is a top view of one embodiment of a sealing member in accordance with embodiments of the invention.

FIG. 7B is a side view of one embodiment of a sealing member in accordance with embodiments of the invention.

FIG. 7C is an enlarged partial view of one embodiment of a sealing member in accordance with embodiments of the invention.

### DETAILED DESCRIPTION OF THE PREFERRED EMBODIMENT

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

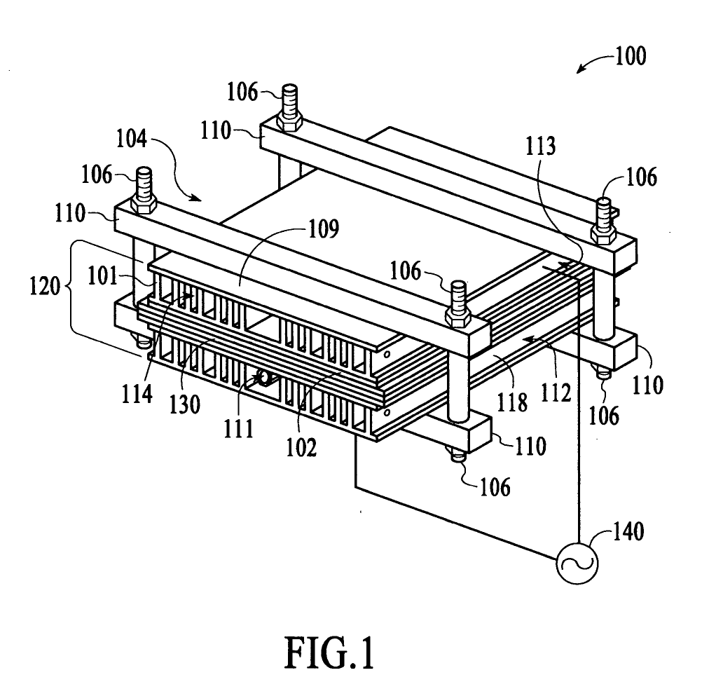

FIG. 1 is a perspective view of one embodiment of an ozone generator 100 in accordance with embodiments of the invention. Ozone generator 100 includes a frame 104. Frame 104 includes two or more clamping members 110 configured to support and apply external clamping pressure to an ozone generator assembly 120. Clamping members 110 may be formed from a variety of materials such as metal, plastic, ceramics, and the like configured to clamp ozone generator assembly 120 therebetween. A plurality of clamping rods 106 may be used to apply pressure to clamping member 110 as known in the art to secure ozone generator assembly 120 therebetween. In one embodiment, clamp members 110 are formed of metal beams configured to apply an about even clamping pressure to ozone generator assembly 120. While only two pairs of clamping members 110 are illustrated, it is contemplated that more than two pairs of clamping members 110 may be used.

Ozone generator assembly 120 includes a lower heat sink assembly 112 and an upper heat sink assembly 114 disposed about a semi-flexible or about rigid insulated ozone production cell 130 disposed therebetween. Both lower heat sink assembly 112 and upper heat sink assembly 114 are configured to structurally support and conduct heat away from ozone production cell 130 to the surrounding ambient atmosphere. For example, lower heat sink assembly 112 may include a plurality of heat sink structures 118 made of aluminum or other heat conductive material used to advantage, configured to conduct heat away from ozone production cell 130. Upper heat sink assembly 114 may include heat sink structures 101 made of metal such as aluminum or other heat conductive material used to advantage. Heat sink structures 101 are disposed adjacent an upper end of ozone production cell 130 and are configured to extract heat therefrom.

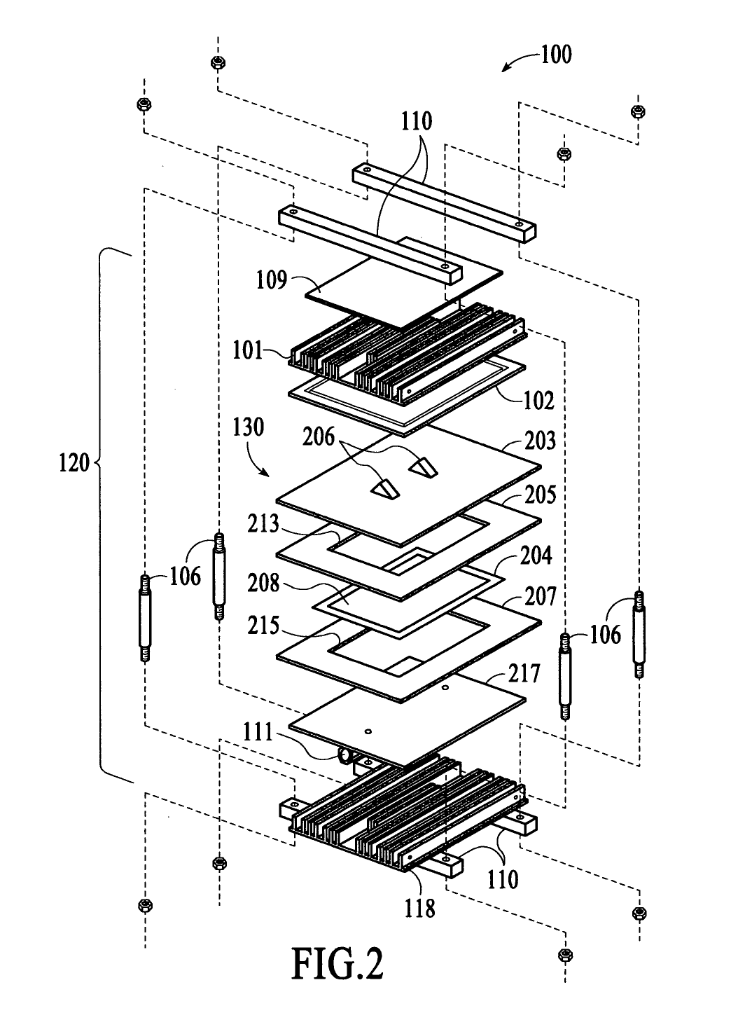

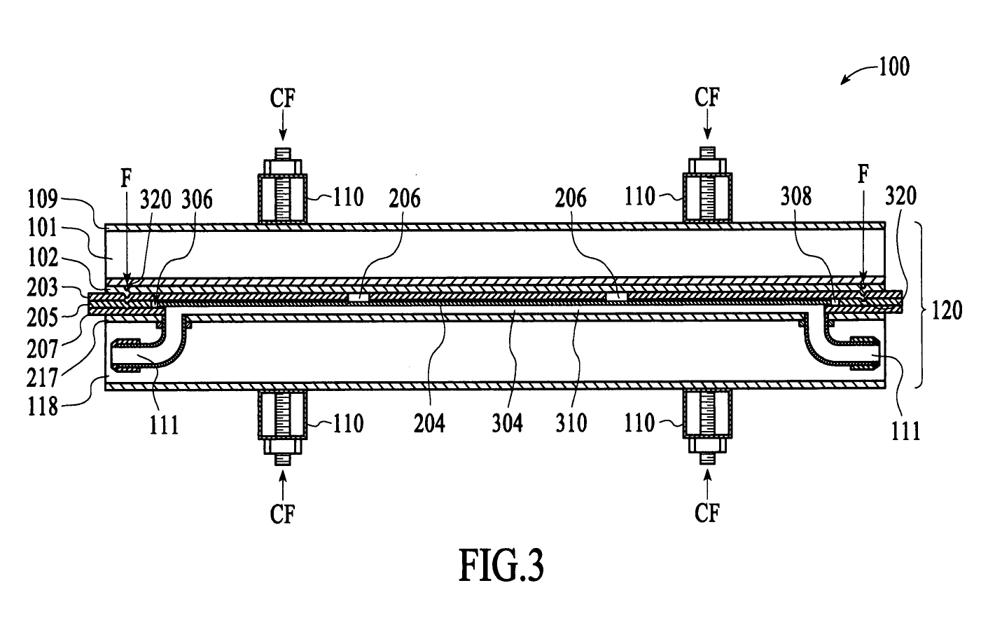

Upper heat sink assembly 114 includes a sealing plate 102. Sealing plate 102 may include materials such as titanium or other materials such as ceramics that resist oxidation by ozone. Sealing plate 102 may also be configured with materials, such as metal, configured to conduct and transfer heat from ozone production cell 130 to heat sink structures 101. In one embodiment, sealing plate 102 and heat sink structures 101 define an upper electrode assembly 113. Upper electrode assembly 113 may be electrically coupled to a power supply 140, such as an AC power, supply configured to supply alternating current and voltage to ozone production cell 130 at a predetermined range of power levels and frequencies. Upper electrode assembly 113 is insulated from frame 104 via an insulator plate 109. Insulator plate 109 may be formed of virtually any insulating material such as fiberglass configured to electrically insulate upper electrode assembly 113 from frame 104. Power supply 140 is also electrically connected to frame 104 and to lower heat sink assembly 112 described further below with respect to FIGS. 2 and 3.

FIG. 2 is an exploded perspective view of one embodiment of an ozone generator 100 of FIG. 1 in accordance with embodiments of the invention. Ozone generator assembly 120 includes a sealing plate 102 disposed above an upper gasket 203. Upper gasket 203 is disposed above a window gasket 205. Upper gasket 203 includes one or more openings therein to allow electrodes 206 to extend therethrough to contact sealing plate 102 on a surface thereof and contact a conductive surface 208 of a dielectric plate 204 positioned adjacent thereto. Window gasket 205 is disposed on a lower gasket 207. Window gasket 205 includes a window opening 213 sized larger than dielectric plate 204 disposed adjacent thereto. Such window opening 213 is sized to loosely accommodate dielectric plate 204 therein while preventing such dielectric plate 204 from lateral motion beyond expansion and contraction as described below. Lower gasket 207 is disposed on an upper surface of a fitting plate 217. Lower gasket 207 includes a process window 215 configured to expose a portion of dielectric plate 204 disposed adjacent thereto to process gasses disposed between dielectric plate 204 and fitting plate 217. Fitting plate 217 is disposed on heat sink structures 118 of lower heat sink assembly 112. Lower heat sink assembly 112 is configured to extract heat from ozone production cell 130 and provide ozone production cell 130 an electrical connection to power supply 140 via fitting plate 217.

In one configuration, upper gasket 203, window gasket 205, lower gasket 207, and fitting plate 217 define an outer boundary of ozone production cell 130, wherein fitting plate 217 defines a lower boundary of ozone production cell 130, and upper gasket 203 defines an upper boundary of ozone production cell 130. Upper gasket 203, window gasket 205, and lower gasket 207 include flexible insulating materials that resist oxidation (e.g., degradation) by ozone such as silicone.

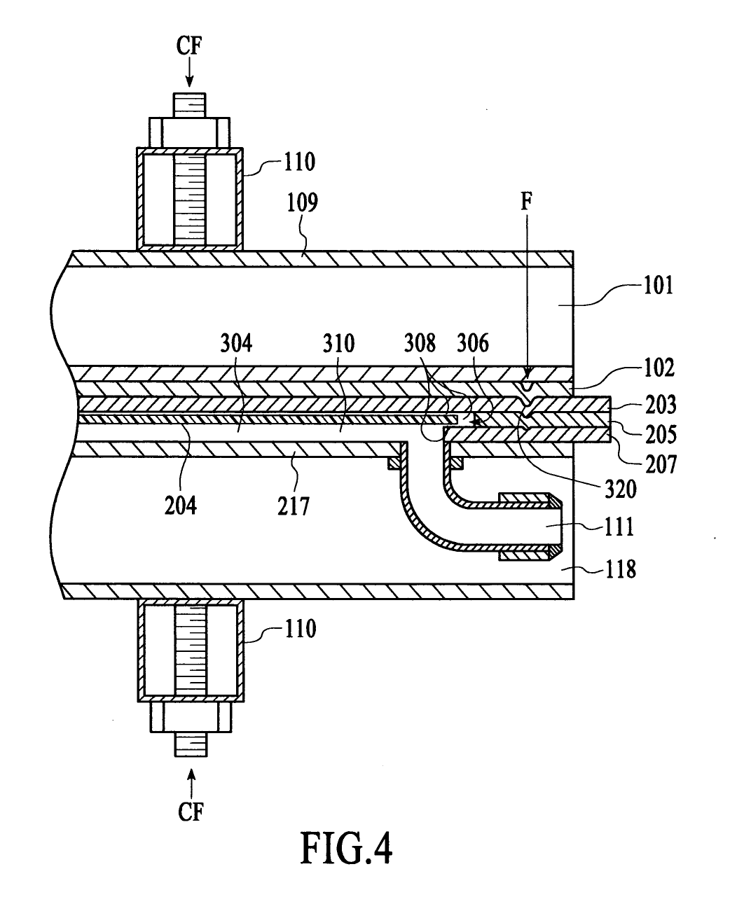

FIG. 3 is a frontal cross sectional view of one embodiment of an ozone generator 100 of FIG. 1 and FIG. 4 is an enlarged view of one end of an ozone generator 100 of FIG. 3 in accordance with embodiments of the invention. In one embodiment, upper gasket 203, window gasket 205, lower gasket 207, and fitting plate 217 define an internally pressurizable ozone process chamber 304. In one embodiment, dielectric plate 204 is loosely disposed within process chamber 304 to allow such dielectric plate 204 to expand and contract without resistance and provide a balanced process gas pressure to all sides of dielectric plate 204. In other words, dielectric plate 204 is disposed in a floating arrangement within process chamber 304.

In one configuration, lower gasket 207, window gasket 205, and upper gasket 203 define a dielectric holding area 306 of process chamber 304. A gap 308 is formed between adjacent portions of upper gasket 203 and lower gasket 207. In one embodiment, a thickness of window gasket 205 defines gap 308. Spacing between internal edges of window gasket 205 define a perimeter of opening 213 (See FIG. 2). Such perimeter is sized to loosely accommodate dielectric plate 204 therebetween to allow for expansion and contraction. Thus, gap 308 and opening 213 define such dielectric holding area 306 configured to accommodate dielectric plate 204 therein, and allow such dielectric plate 204 to expand and contract over a predetermined operational temperature range without resistance.

In one embodiment, fitting plate 217 is configured as an electrode plate and is separated from dielectric plate 204 by a predetermined distance defining an ozone production chamber 310 portion of process chamber 304. Ozone production chamber 310 is configured such that during operation a process gas under pressure is exposed to a corona discharge formed by an electric field disposed between an exposed area of fitting plate 217 and dielectric plate 204 to produce ozone gas. Such exposed area of fitting plate 217 is defined by window opening 215.

In one configuration, fitting plate 217 is configured with at least two gas ports 111. Gas ports 111 may be configured integral to or affixed to fitting plate 217 to prevent leakage of process and ozone gas therefrom. For example, gas ports 111 may be tubular connections welded to fitting plate 217. At least one of gas ports 111 is configured to receive process gas, such as oxygen, under pressure from an external process gas supply (not shown) and couple such process gas into process chamber 304 and into ozone production chamber 310. Gas ports 111 may also be configured to output ozone gas under pressure from ozone production chamber 310 to external systems (not shown) configured to receive such pressurized ozone gas. For example, one or more gas ports 111 may be configured to receive and couple process gas on one side of ozone production chamber 310. At least one other gas port 111 may be disposed on a distal side of such ozone production chamber 310 to output pressurized ozone gas therefrom. In one arrangement, gas ports 111 and ozone production chamber 310 are configured to allow process gas to flow therein within a predetermined range of flow rates to allow a user to control process gas processing time, throughput, and ozone gas concentration.

In one embodiment, one or more electrodes 206 (See FIG. 2 and FIG. 3) extend from a portion of sealing plate 102 through upper gasket 203 to a conductive side 208 of dielectric plate 240. Power supply 140 (See FIG. 1) may be coupled to electrodes 206 directly using connections as known and via upper electrode assembly 113. Electrodes 206 may be configured in a flexible spring arrangement such that as dielectric plate 204 expands and contracts electrodes 206 stay in contact therewith without applying significant contact pressure thereto.

In one embodiment, sealing plate 102 includes a sealing member 320 extending from sealing plate 102 towards the upper gasket 203. Sealing member 320 is configured to supply a force F focused over a predetermined area of upper gasket 203 to form a sealing pressure without significantly altering gap 308. For example, force F may be established by clamping member 110 under a given clamping force CF to allow sealing member 320 to impinge upon an external surface of upper gasket 203 while leaving gap 308 about unchanged in dimension. At least some of force F extends though upper gasket 203, window gasket 205, and lower gasket 207. In one configuration, as illustrated in FIG. 4, force F is sufficient to deform upper gasket 203, window gasket 205, and lower gasket 207 to provide a process gas seal therebetween, while allowing gap 308 to be about maintained within a predetermined dimensional range.

In one configuration, sealing member 320 may be configured in width and in height to accommodate a variety of process gas pressure ranges. For example, to increase force F, sealing member 320 may be increased in height such that a greater force F is produced as sealing member 320 is urged in contact with upper gasket 203. In another example, sealing member 320 may be increased in width at a given clamping force CF such that force F is dispersed across a larger area of upper gasket 203, window gasket 205, and lower gasket 207. Such a width and clamping force CF may be configured to apply sufficient force F to upper gasket 203 to provide a sufficient gas seal, while not significantly affecting (e.g., narrowing) gap 308.

In one configuration, force F is sufficient to secure upper gasket 203, window gasket 205, and lower gasket 207 from significant lateral movement. For example, force F may be established by clamping member 110 under a predetermined range of clamping force CF such that upper gasket 203, window gasket 205, and lower gasket 207 maintain lateral position over a range of increased process gas pressures within chamber 304. Sealing member 320 may be shaped to prevent such lateral movement. For example, sealing member 320 may be generally rectangular in shape and configured such that a portion of its edges disposed adjacent and in contact with upper gasket 203 provide sufficient deformation to upper gasket 203, window gasket 205, and lower gasket 207 to interlock upper gasket 203, window gasket 205, and lower gasket 207 together without significantly altering gap 308.

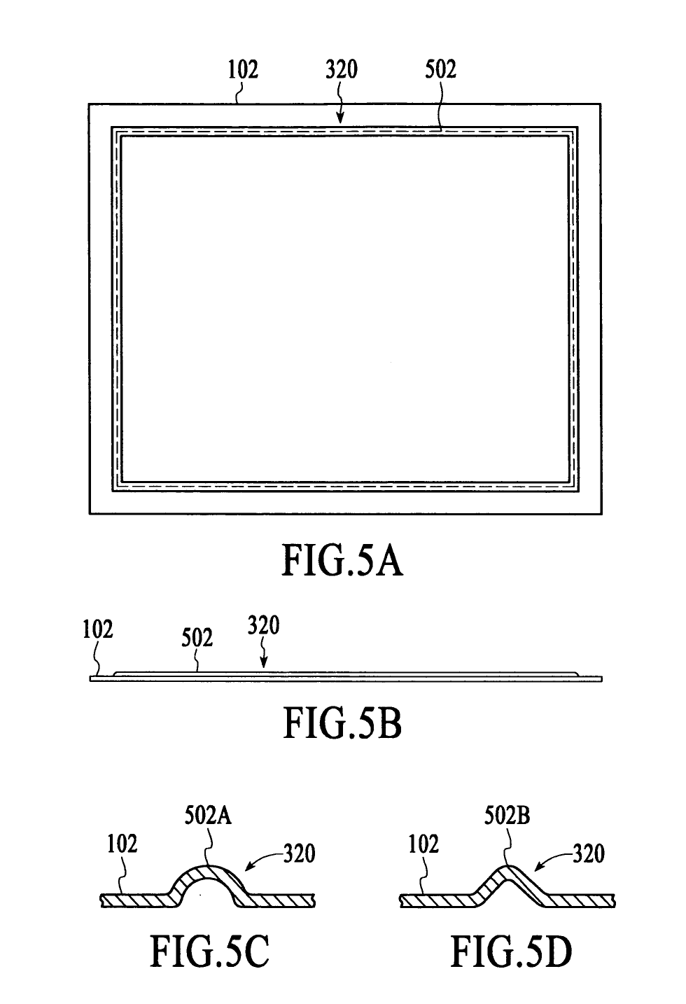

FIG. 5A is a top view and FIG. 5B is a side view of one embodiment of a sealing plate 102 in accordance with embodiments of the invention. FIGS. 5C and 5D are enlarged partial views of one embodiment of a sealing plate 102 of FIG. 5A and FIG. 5B in accordance with embodiments of the invention. In one configuration, sealing plate 102 includes a sealing member 320 extending therefrom. In one embodiment, sealing member 320 is configured as a ridge shaped structure 502 extending from plate 102. Ridge shaped structure 502 may be formed in a variety of shapes on plate 102 such as round, square, oval, rectangular, etc., or in a custom pattern that may be used to advantage. For example, ridge shaped structure 502 may be formed in a general rectangular shape as illustrated in FIG. 5A.

Ridge shaped structure 502 may be aligned such that sealing force F may be applied to and extend though an upper gasket 203 to a window gasket 205 and a lower gasket 207 when ridge shaped structure 502 is urged against upper gasket 203 at a predetermined force (See FIG. 3). Such pressure may be associated with, for example, a clamping force CF of clamp members 110. Ridge shaped structure 502 may also be configured to follow and accommodate a variable pressure pattern formed between upper gasket 203, window gasket 205, and lower gasket 207 clamped together under a given range of clamping force CF to improve sealing. For example, as illustrated in FIG. 3, clamping force CF may be concentrated along a longitudinal axis of each pair of clamping members 110, wherein clamping force CF may be somewhat diminished therebetween. To accommodate such a variation in clamping force CF, ridge shaped structure 502 may be formed in width, height, and shape to increase force F in areas that have reduced clamping force CF and decrease force F in other areas as desired.

In one embodiment, ridge shaped structure 502 may be formed in a variety of ways integral sealing plate 102. For example, ridge shaped structure 502 may be formed by stamping and molding such ridge shaped structure 502 into sealing plate 102. Ridge shaped structure 502 may also be formed as a separate structure from material such as metal and gasket structures as described below.

As illustrated in FIG. 5C and FIG. 5D, ridge shaped structure 502 may also be formed with a plurality of different shapes to focus force F as desired. For example, as illustrated in FIG. 5C, ridge shaped structure 502 may be a rounded sealing member 502A to focus force F more broadly. Such a broad focus of force F may be configured to increase a sealing area without significantly affecting gap 308. Ridge shaped structure 502 may also be formed as a v-shaped member 502B that focuses sealing force F in a narrower pattern than rounded sealing member 502A. Such a narrower sealing pattern may accommodate a seal that further interlocks upper gasket 203, window gasket 205, and lower gasket 207 from lateral movement under increased processing pressures.

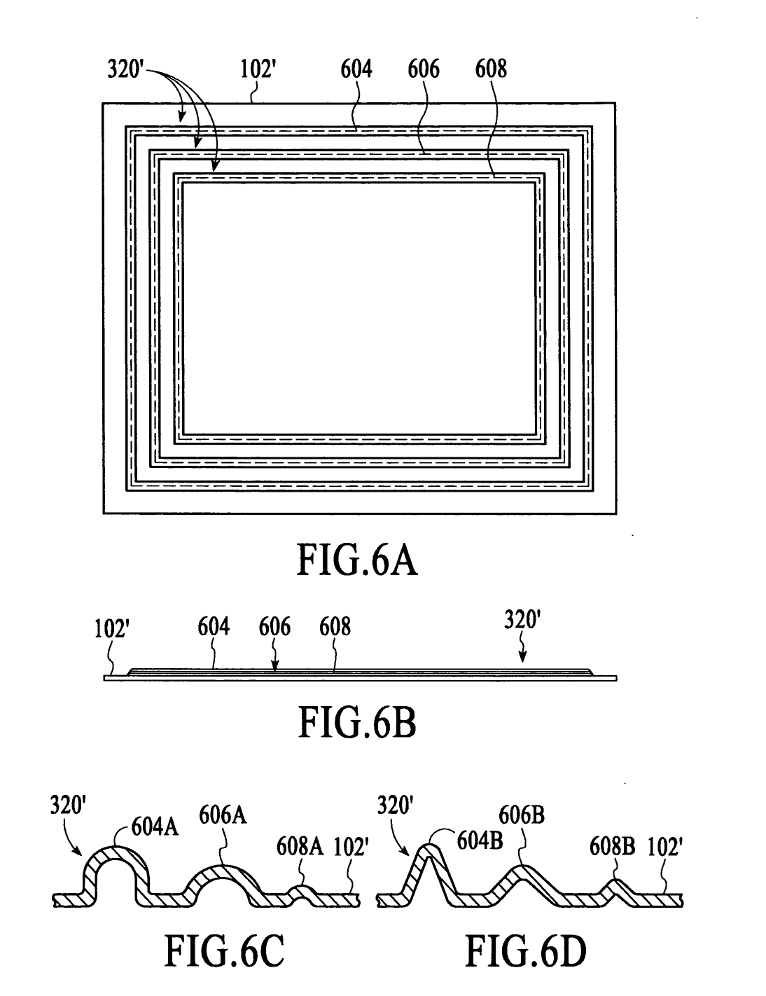

FIG. 6A is a top view and FIG. 6B is a side view of one embodiment of a sealing plate 102′ in accordance with embodiments of the invention. FIGS. 6C and 6D are enlarged partial views of one embodiment of sealing plate 102′ of FIG. 6A and FIG. 6B in accordance with embodiments of the invention. In one configuration, sealing plate 102′ includes a sealing member 320′ extending therefrom that includes a plurality of ridge type structures. For example, sealing member 320′ may include an outer ridge 604, middle ridge 606, and inner ridge 608. Outer ridge 604, middle ridge 606, and inner ridge 608 may be configured with similar or different heights and widths to provide a plurality of forces F at different force levels as described herein that may be used for similar or different purposes. For example, as illustrated in FIGS. 6C and 6D, an outer ridge 604A may be configured with a greater height than a middle ridge 606A and an inner ridge 608A to provide a greater force F relative thereto. As further illustrated in FIG. 6C and FIG. 6D, sealing member 320′ may also be formed with a plurality of different shapes to focus sealing force F as desired. For example, as illustrated in FIG. 6C, outer ridge 604A, middle ridge 606A, and inner ridge 608A may be a rounded in shape. Such a rounded shape may be configured to increase a sealing area without adversely affecting gap 308. Sealing member 320′ may also be formed as a v-shaped outer ridge 604B, v-shaped middle ridge 606A, and v-shaped inner ridge 608B that focuses sealing force F in a narrower pattern than rounded outer ridge 604A, middle ridge 606A, and inner ridge 608A. Such a narrower sealing pattern may accommodate a seal that further interlocks upper gasket 203, window gasket 205, and lower gasket 207 from lateral movement under increased processing pressures.

While outer ridge 604, middle ridge 606, and inner ridge 608 are shown as continuous structures, it is contemplated that only one of outer ridge 604, middle ridge 606, and inner ridge 608 may be configured to provide a seal. One or more of outer ridge 604, middle ridge 606, and inner ridge 608 may be other structures such as dimples, pits, or other structures configured to provide an interlocking force described herein between upper gasket 203, window gasket 205, and lower gasket 207.

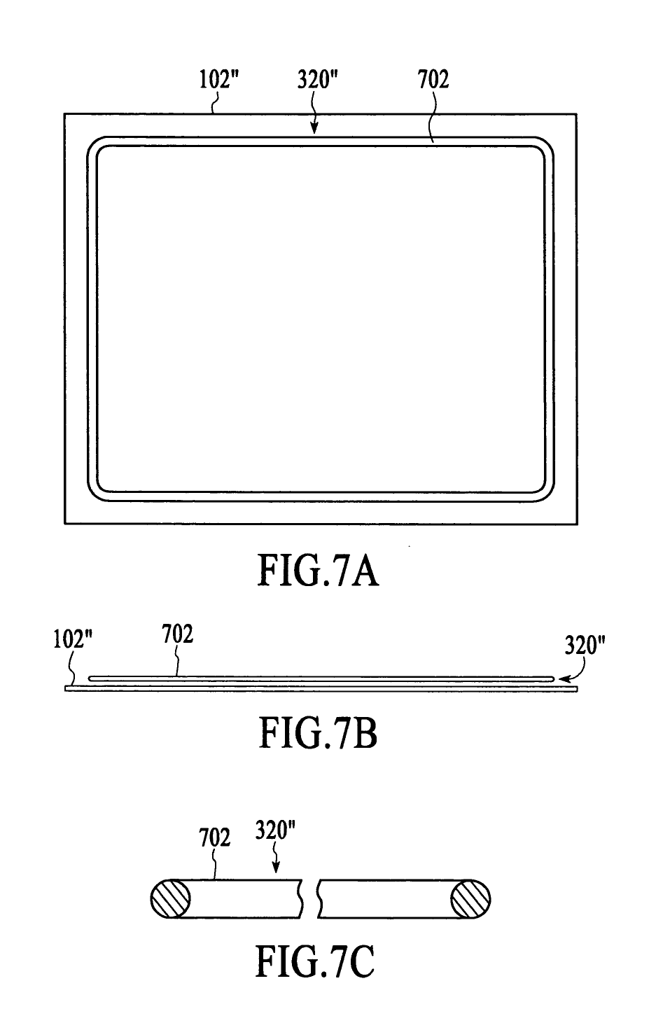

FIG. 7A is a top view, FIG. 7B is a side view, and FIG. 7C is a enlarged partial view of one embodiment of a sealing member 320″ in accordance with embodiments of the invention. In one configuration, sealing member 320″ may be formed as an independent gasket member 702 disposed between a sealing plate 102″ and upper gasket 203. Gasket member 702 may be formed of virtually any material such as metal, plastic, or ceramic that may be used to advantage. For example, gasket member 702 may be formed of tubular metal rods as illustrated in FIG. 7C. While for clarity, gasket member 702 may be disposed between plate 102″ and upper gasket 203, it is contemplated that one or more gasket members 702 may be place between upper gasket 203 and window gasket 205, and placed between window gasket 205 and lower gasket 207 to provide a similar sealing force F described herein. Further, one or more gasket members 702 may be placed between heat sink assembly 118 and lower gasket 207 to provide such a similar sealing force F.

In summary, ozone generator 100 includes upper gasket 203, window gasket 205, lower gasket 207, and fitting plate 217 that define an insulated semi-flexible or about rigid ozone production cell 130. Ozone production cell 130 includes a process chamber 304 therein configured to accommodate a process to generate ozone gas at a higher pressure than a surrounding ambient air pressure while allowing for heat exchange therefrom to such ambient environment via lower heat sink assembly 112 and upper heat sink assembly 114. Process chamber 304 is bounded by rigid and flexible materials resistant to ozone gas degradation and is configured such that internal pressure may be increased to many times that of a surrounding ambient air pressure while allowing high pressure ozone gas to be produced therein within predetermined concentration levels. Process chamber 304 includes a dielectric holding area 306 that is configured to loosely entrap dielectric plate 204 therein and allow dielectric plate 204 to expand and contract without resistance. In one arrangement, ozone generator 100 includes a sealing member 320 disposed between sealing plate 102 and upper gasket 203. Sealing member 320 is configured with one or more structures that are configured in height, width, and in shape to provide at least some sealing force F with a magnitude sufficient for sealing process chamber 304 to prevent leakage of process and ozone gas under pressure therefrom without adversely affecting an expansion and contraction of dielectric plate 204, and for supporting upper gasket 203, window gasket 205, and lower gasket 207 laterally.

### OPERATIONAL EXAMPLE

For clarity, ozone concentration is described in terms of an operable level of ozone output, however, it is contemplated that similar variations in ozone concentration over a range of output ozone gas pressure may be seen at a plurality of different process gas input pressure levels.

In one operational embodiment, a process gas under pressure is coupled into process chamber 304 of the present invention (See FIG. 3) at or above ambient pressure (e.g., 14.7 psi) via one or more gas ports 111 configured to receive such pressurized process gas. Power supply 140 is configured at a nominal power level P to provide an alternating voltage differential between fitting plate 217 and conductive area 208 of dielectric plate 204 over a range of frequencies configured to generate an electrical corona within ozone production chamber 310. Process gas flows from such input gas port 111 through such electrical corona to produce ozone gas. Such ozone gas flows toward and is discharged from another one or more gas ports 111 configured to output such ozone gas.

For comparison purposes, an ozone output was measured indicative of a pressurized process gas under similar testing conditions processed by a prior art ozone generator described in U.S. Pat. No. 5,512,254 incorporated herein by reference in its entirety. Ozone output of such prior art ozone generator was tested operable between zero gage pressure and about one additional atmosphere at a power level P. At slightly above such one additional atmosphere, ozone gas output for such prior art ozone generator dropped to about zero due to severe process gas leakage. Thus, such prior art ozone generator proved operable with a process gas pressure of between ambient pressure (e.g., zero gage pressure) and about one additional atmospheric pressure above ambient atmospheric pressure at a given power level P.

Under similar conditions, an operational range of ozone generator 100 of the present invention was tested at power level P. In one operational test, ozone generator 100 provided ozone output between a process gas pressure of about ambient pressure (i.e., zero gage pressure) to about three times ambient pressure. Ozone production dropped due to an increase in dielectric constant of such process gas under pressure at a power level P. Thus, such ozone generator 100 of the present invention proved operable with a process gas pressure between ambient atmospheric pressure and about three times ambient atmospheric pressure at a similar power level P.

For clarity, such operational illustration is described in terms of a given power level P and ozone production chamber 310 having a volume defined partially by a distance between fitting plate 217 and dielectric plate 204. However, it is contemplated that operational pressure of ozone generator 100 of the present invention may be increased given a reduction in a distance between fitting plate 217 and dielectric plate 304 and an increase in power from power supply 140 sufficiently to accommodate an increase in dielectric constant of a pressurized process gas therein to produce ozone at acceptable levels. For example, decreasing the distance between fitting plate 217 and dielectric plate 304 to about one half (i.e., 0.5) a nominal distance value, while keeping a constant power level P, was tested to increase an operable ozone output of ozone generator 100 by a factor of about two times. Thus, decreasing such distance between fitting plate 217 and dielectric plate 304 about one half a nominal value increased an operable pressure range of ozone generator 100 of the present invention from about ambient atmospheric pressure to about six times ambient atmospheric pressure (e.g., zero gage pressure to about 90 psi) at a power level P, while allowing heat to be transferred from ozone production cell 130 to the ambient atmosphere.

In summary, ozone generator 100 includes an about rigid or semi-flexible insulated ozone production cell 130 disposed between lower heat sink assembly 112 and upper heat sink assembly 114 (See FIGS. 1-4). In one embodiment, ozone production cell 130 with a nominal distance (e.g., gap) between the fitting plate 217 and the dielectric plate 204 is configured to accommodate internal process gas pressures of about three times a surrounding ambient atmospheric pressure while providing an output gas at about such internal pressure that includes ozone gas component at predetermine operable concentration levels. With about one half such nominal distance, ozone production cell 130 may accommodate process gasses at a pressure of about six times ambient atmospheric pressure without significant changes to power supply 140. It is contemplated, that increasing power output of power supply 140 and with such a narrower distance, ozone production cell 130 may accommodate process gasses at a pressure of about nine times ambient atmospheric pressure, or more, (e.g. about zero gage pressure to about 135 psi) while providing a desired ozone concentration. Ozone generator 100 is configured such that during operation lower heat sink assembly 112 and upper heat sink assembly 114 extract and dissipate heat from ozone production cell 130 into such ambient atmosphere regardless of internal process gas pressures.

While the foregoing is directed to embodiments of the present invention, other and further embodiments of the invention may be devised without departing from the basic scope thereof, and the scope thereof is determined by the claims that follow.

1. An apparatus configured to generate high pressure ozone gas from a high pressure process gas containing oxygen, the apparatus comprising:
a sealing plate;
an upper gasket disposed on the sealing plate;
a window gasket disposed on the upper gasket;
a lower gasket disposed on the window gasket;
an electrode plate disposed on the lower gasket;
the electrode plate, the lower gasket, the window gasket, and the upper gasket, cooperate to form a pressurizable process chamber;
a dielectric plate is disposed within the pressurizable process chamber in a dielectric plate receiving space defined by the window gasket, the upper gasket, and the lower gasket, the dielectric plate receiving space is sized to allow the dielectric plate to expand and contract without resistance over a range of operational temperatures;
at least one electrical contact extending between the sealing plate through an opening in the upper gasket to electrically connect a conductive side of the dielectric plate to the sealing plate;
a power source electrically connected to the electrode plate and the at least one electrical contact;
at least one gas input integral to the electrode plate is configured to couple the high pressure process gas into the pressurizable process chamber;
at least one gas output integral to the electrode plate is configured to output the high pressure ozone gas from the pressurizable process chamber; and
a sealing member disposed between the sealing plate and the upper gasket, the sealing member being configured to apply a focused sealing force that extends through the upper gasket, the window gasket, and the lower gasket such that a seal is formed around the pressurizable process chamber, the seal provides a sufficient pressure seal to allow gas pressure within the pressurizable process chamber to be at least about three times greater than an ambient atmospheric pressure external to the apparatus.

2. The apparatus of claim 1, wherein the focused sealing force is sufficient in magnitude to deform a portion of the upper gasket, window gasket, and the lower gasket to impede lateral movement of the upper gasket, window gasket, and the lower gasket.

3. The apparatus of claim 1, wherein the sealing member comprises a ridge shaped structure integral to and extending from the sealing plate, the ridge shaped structure having a width and height configured to generate the focused sealing force when urged against the upper gasket within a predetermined force range.

4. The apparatus of claim 1, wherein the sealing member comprises a plurality of ridge shaped structures extending from and integral to the sealing plate, the plurality of ridge shaped structures each having a width and height configured to generate a plurality of focused sealing forces that are generated when the plurality of ridge shaped structures are urged against the upper gasket within a predetermined force range.

5. The apparatus of claim 1, wherein the sealing member comprises at least one tubular shaped member disposed between the sealing plate and the upper gasket.

6. The apparatus of claim 1, wherein the sealing member is positioned between the electrode plate and the lower gasket.

7. The apparatus of claim 6, wherein the sealing member comprises a ridge shaped structure extending from and integral to the electrode plate, the ridge shaped structure having a width and height configured to generate the focused sealing force when urged against the lower gasket within a predetermined force range.

8. The apparatus of claim 6, wherein the sealing member comprises a plurality of ridge shaped structures extending from and integral to the electrode plate, the plurality of ridge shaped structures each having a width and height configured such that each generates a respective focused sealing force when urged against the lower gasket within a predetermined force range.

9. The apparatus of claim 6, wherein the sealing member comprises at least one tubular shaped structure disposed between the electrode plate and the lower gasket.

10. An ozone generator configured to receive a process gas containing oxygen under pressure, process such process gas, and output ozone gas at a pressure greater than ambient air pressure, the ozone generator comprising:
an insulated body configured with an expansion cavity disposed adjacent a corona discharge cavity;
a dielectric plate disposed within the expansion cavity, the expansion cavity being sized to allow the dielectric plate to expand and contract within the expansion cavity without resistance;
an electrode plate disposed adjacent the corona discharge cavity and the dielectric plate; and
a sealing plate having a sealing means disposed adjacent thereto and extending therefrom toward the electrode plate, the sealing means is configured to provide a sealing force that extends through the insulated body sufficient to provide a process gas seal about the corona discharge cavity and the expansion cavity, the sealing force being of sufficient magnitude to allow the ozone generator to receive the process gas therein at a process gas pressure of at least about three times greater than the ambient air pressure surrounding the insulated body and output the ozone gas at about the process gas pressure.

11. The ozone generator of claim 10, wherein the sealing means is disposed between the electrode plate and the insulated body, wherein the sealing means provides the sealing force extending though the insulated body to the sealing plate.

12. The ozone generator of claim 10, wherein the sealing means is sufficient in height to deform the insulated body respective to the sealing force to prevent the insulated body from moving laterally under the process gas pressure.

13. The ozone generator of claim 10, wherein the sealing means comprises a ridge structure extending from the sealing plate toward the electrode plate.

14. The ozone generator of claim 13, wherein the ridge structure includes at least two ridge structures.

15. The ozone generator of claim 14, wherein one of the at least two ridge structures provides the sealing force and another one of the at least one two ridge structures provides a force that about prevents the insulated body from lateral movement in response to the pressure of the process gas.

16. A method of generating high pressure ozone gas within an internal ozone generation chamber configured to accommodate a process gas containing oxygen under pressure greater than an ambient atmospheric pressure, the method comprising:
providing an insulated process chamber configured to receive the process gas under pressure, the insulated process chamber including a dielectric expansion chamber configured to support a dielectric plate therein without resistance, and a corona discharge chamber;
positioning a sealing plate on one side of the insulated process chamber;
positioning an electrode plate on another side of the insulated process chamber adjacent the dielectric plate to define the corona discharge chamber;
providing the process gas to the corona discharge chamber;
generating a corona discharge within the corona discharge chamber to produce the high pressure ozone gas; and
providing a sealing member extending from the sealing plate toward the insulated process chamber, the sealing member is configured to engage with the insulated process chamber with sufficient force to generate a sealing force extending though the insulated process chamber between the sealing plate and the electrode plate, the sealing force being sufficient to allow the insulated process chamber to accommodate the process gas at a pressure of at least about three times greater than the ambient air pressure surrounding the insulated process chamber.

17. The method of claim 16, wherein the insulated process chamber comprises silicon.

18. The method of claim 16, wherein the insulated process chamber comprises a first gasket disposed between the sealing plate and the insulated process chamber, the first gasket being configured to conform to the shape of the sealing structure and develop a sealing force therethrough in response to the shape of sealing structure.

19. The method of claim 16, wherein providing an insulated process chamber comprises providing a first gasket below the sealing plate, providing a window gasket on the first gasket, the widow gasket including a opening therein sized to accommodate the dielectric plate therein, providing a second gasket on the window gasket, wherein the second gasket cooperates with the electrode plate, the window gasket, and the first gasket to form the insulated process chamber.

20. The method of claim 16, wherein the sealing force extends into the insulated process chamber over a width significantly narrower than the surface area of the insulated process chamber to seal the insulated process chamber without significantly altering affecting the dielectric expansion chambers configuration to support the dielectric plate therein without resistance.
